(19) United States
(12) Patent Application Publication
(10) Pub. No.: US 2017/0342353 A1
(43) Pub. Date: Nov. 30, 2017

(54) PROCESS FOR WASHING FABRICS

(71) Applicant: The Procter & Gamble Company, Cincinnati, OH (US)

(72) Inventors: Neil Joseph LANT, Newcastle upon Tyne (GB); Stefano SCIALLA, Strombeek-Bever (BE); Linsey Sarah FULLER, Newcastle upon Tyne (GB); Robby Renilde François KEULEERS, Lippelo (Sint Amands) (BE); Alan Thomas BROOKER, Newcastle upon Tyne (GB)

(21) Appl. No.: 15/605,121

(22) Filed: May 25, 2017

(30) Foreign Application Priority Data
May 26, 2016 (EP) 16171596.6
May 22, 2017 (WO) US2017/033786

(51) Int. Cl. C11D 3/39; C11D 1/94; C11D 11/00; D06F 35/00; D06F 33/02

(52) U.S. Cl. CPC C11D 3/392; D06F 35/006; D06F 33/02; C11D 11/0017; C11D 3/3945; C11D 1/94; C11D 3/3932; C11D 3/3917; C11D 3/3915; C11D 3/3942

(57) ABSTRACT

A process for washing fabrics including the steps; a) contacting fabrics to be washed and a wash liquor in the drum of an automatic washing machine; b) washing the fabrics in the wash liquor in an automatic washing machine process, where the automatic washing machine process includes at least a main wash step; where the wash liquor includes; i) between about 0.5 ppm and about 5 ppm acyl hydrazone bleach catalyst; ii) between about 10 ppm and about 2500 ppm non-soap surfactant; iii) between about 50 ppm and about 2500 ppm of a hydrogen peroxide source, and where the wash liquor has a pH between about 6 and about 9.

### FIELD OF THE INVENTION

The present disclosure relates to a process for washing fabrics comprising an acyl hydrazone bleach catalyst.

### BACKGROUND OF THE INVENTION

Bleaching compounds are often used during fabric washing operations. However, traditional wash processes have required more alkaline conditions to maximize the cleaning effect of the bleach compounds. However, there is a need for a process for cleaning fabrics at a range of pHs including more acidic wash conditions.

Furthermore, there is a need for wash processes that are more environmentally friendly, yet still provide excellent fabric cleaning.

It was surprisingly found that the process of the present invention allowed for excellent fabric cleaning under a range of pH conditions including more acidic conditions, and also a more environmentally friendly process, such as lower water consumption and lower wash temperatures, whilst still maintain excellent cleaning.

### SUMMARY OF THE INVENTION

The present disclosure relates to a process for washing fabrics comprising the steps;
a. Contacting fabrics to be washed and a wash liquor in the drum of an automatic washing machine;
b. Washing the fabrics in the wash liquor in an automatic washing machine process, wherein the automatic washing machine process comprises at least a main wash step;
wherein the wash liquor comprises;
   i. Between 0.5 ppm and 5 ppm acyl hydrazone bleach catalyst;
   ii. Between 10 ppm and 2500 ppm non-soap surfactant;
   iii. Between 50 ppm and 2500 ppm of a hydrogen peroxide source, and
wherein the wash liquor has a pH between 6 and 9.

### DETAILED DESCRIPTION OF THE INVENTION

### Wash Process

The present disclosure relates to a process for washing fabrics. By fabric we preferably mean a textile or cloth comprising a network of natural or artificial fibres. Preferably the fabrics are ones that are worn by consumers such as clothing.

The process for washing fabrics comprises the step;
a. Contacting fabrics to be washed and a wash liquor in the drum of an automatic washing machine.

Preferably the fabrics to be washing comprise at least one stain or soil to be removed during the wash operation.

The fabrics are contacted with a wash liquor in the drum of an automatic washing machine. The articles to be washed may be contacted with the wash liquor or the wash liquor may be contacted with the articles to be washed. Alternatively, the articles to be washed may be present within a washing machine and the wash liquor is formed around them. The wash liquor is described in more detail below.

The process comprises the further step of;
b. Washing the fabrics in the wash liquor in an automatic washing machine process, wherein the automatic washing machine process comprises at least a main wash step.

Those skilled in the art will be aware of standard washing machine processes. The skilled person will know how select such a process on a standard washing machine. Without wishing to be bound by theory, washing machine processes comprise at least a main wash step. They may comprise other steps such as rinse steps, pre-wash steps or a mixture thereof.

The main wash may take between 5 minutes and 50 minutes, preferably between 5 minutes and 40 minutes, more preferably between 5 minutes and 30 minutes, even more preferably between 5 minutes and 20 minutes, most preferably between 6 minutes and 18 minutes.

The main wash step may comprise the addition of between 10 L and 60 L, preferably between 10 L and 40 L, more preferably between 10 L and 30 L, most preferably between 10 L and 20 L of water to the drum of the automatic washing machine.

The temperature of the water in the main wash step may be between 10° C. and 45° C., preferably between 15° C. and 35° C.

The automatic washing process may comprise at least one rinse step. The automatic washing machine process may comprise a final rinse step, preferably wherein the drum of the automatic washing machine rotates at a speed of between 500 rpm and 1700 rpm during the final rinse step.

Without wishing to be bound by theory, it is the specific steps in the present process that enable excellent fabric cleaning under a range of pH conditions including more acidic conditions, and also a more environmentally friendly process. Lower wash volumes and temperatures are less resource and energy intensive so resulting in a more environmentally friendly process but one in which the fabrics are still cleaned to a consumer accepted level.

### Wash Liquor

The wash liquor comprises;
i. Between 0.5 ppm and 5 ppm acyl hydrazone bleach catalyst;
ii. Between 10 ppm and 2500 ppm non-soap surfactant;
iii. Between 50 ppm and 2500 ppm of a hydrogen peroxide source, and
   wherein the wash liquor has a pH between 6 and 9.

The acyl hydrazone bleach catalyst is described in more detail below.

The wash liquor may have a pH between 7 and 8.5.

The hydrogen peroxide source may be selected from alkali metal perborates, alkali metal percarbonates, urea perhydrates, peroxycarboxylic acids, alkali metal persulfates, alkali metal peroxydisulfates, Caroates, diacyl peroxides,tetraacyl diperoxides or a mixture thereof.

The wash liquor may comprises between 250 ppm and 2000 ppm, preferably between 500 ppm and 1500 ppm of the hydrogen peroxide source.

The wash liquor may comprise between 15 ppm and 1000 ppm, preferably between 50 ppm and 800 ppm, of non-soap surfactant.

The non-soap surfactant may be selected from anionic surfactants, non-ionic surfactants, cationic surfactants or a mixture thereof. Exemplary anionic surfactants are the alkali metal salts of C₁₀-C₁₆ alkyl benzene sulfonic acids, or C₁₁-C₁₄ alkyl benzene sulfonic acids. In one aspect, the alkyl group is linear and such linear alkyl benzene sulfonates are known as “LAS”. Alkyl benzene sulfonates, and particularly LAS, are well known in the art. Especially useful are the sodium, potassium and amine linear straight chain alkylbenzene sulfonates in which the average number of carbon atoms in the alkyl group is from about 11 to 14.

Specific, non-limiting examples of anionic surfactants useful herein include the acid or salt forms of: a) C₁₁-C₁₈ alkyl benzene sulfonates (LAS); b) C₁₀-C₂₀ primary, branched-chain and random alkyl sulfates (AS), including predominantly C₁₂ alkyl sulfates; c) C₁₀-C₁₈ secondary (2,3) alkyl sulfates with non-limiting examples of suitable cations including sodium, potassium, ammonium, amine and mixtures thereof; d) C₁₀-C₁₈ alkyl alkoxy sulfates (AEₓS) wherein x is from 1-30; e) C₁₀-C₁₈ alkyl alkoxy carboxylates in one aspect, comprising 1-5 ethoxy units; f) mid-chain branched alkyl sulfates; g) mid-chain branched alkyl alkoxy sulfates; h) modified alkylbenzene sulfonate; i) methyl ester sulfonate (MES); and j) alpha-olefin sulfonate (AOS).

The anionic surfactant may be selected from linear alkylbenzene sulphonate, alkoxylated alkyl sulfate, or a mixture thereof.

The wash liquor may comprise between 10 ppm and 2500 ppm, preferably between 20 ppm and 1000 ppm, more preferably between 50 ppm and 800 ppm of linear alkylbenzene sulphonate.

The wash liquor may comprise between 2 ppm and 650 ppm, preferably between 5 ppm and 600 ppm, more preferably between 15 ppm and 300 ppm alkoxylated alkyl sulphate, preferably ethoxylated alkyl sulphate.

The non-ionic surfactant may be selected from fatty alcohol alkoxylate, an oxo-synthesised fatty alcohol alkoxylate, Guerbet alcohol alkoxylates, alkyl phenol alcohol alkoxylates or a mixture thereof.

The wash liquor may comprise between 1 ppm and 650 ppm, preferably between 2 ppm and 500 ppm, most preferably between 4 ppm and 350 ppm non-ionic surfactant.

The wash liquor may comprise a bleach activator, preferably wherein the bleach activator is selected from Tetra-Acetyl-Ethylene-Diamine (TAED), nonanoyl oxybenzene sulphonate (NOBS), dodecanoyl oxybenzene sulphonate (DOBS), decanoyl oxybenzoic acid (DOBA), acetyl glucose-type activators e.g. PentaAcetyl Glucose (PAG) or a mixture thereof.

The wash liquor may comprise a second bleach catalyst, wherein the second bleach catalysts is different to the acyl hydrazone. The second bleach catalyst may comprise a complex of a transition metal, an aryliminium organic bleach catalysts or a mixture thereof.

The complex of a transition metal may comprise manganese, and a cross-bridged macropolycyclic ligand.

Aryliminium organic bleach catalysts improve the bleaching performance, particularly at low temperatures. They are capable of accepting an oxygen atom from an oxygen-based bleach source and transferring the oxygen atom to an oxidizable substrate. The bleaching system for use in the present invention may also include other bleaching agents such as those selected from the group comprising additional bleach activators, metal-containing bleach catalysts, transition metal complexes of macropolycyclic rigid ligands, and mixtures thereof.

The aryliminium organic bleach catalyst may be selected from the group comprising aryliminium cations, aryliminium zwitterions, and mixtures thereof. Suitable aryliminium zwitterions may be selected from the group comprising:

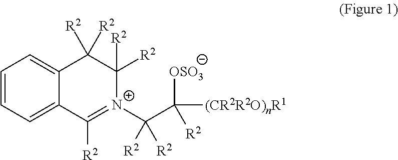

wherein: in FIG. 1, R¹ is selected from the group consisting of: H, a branched alkyl group containing from 3 to 24 carbons, and a linear alkyl group containing from 1 to 24 carbons. Preferably, R¹ is a branched alkyl group comprising from 6 to 18 carbons, or a linear alkyl group comprising from 5 to 18 carbons, more preferably each R¹ is selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons. Preferably R² is independently selected from H and methyl groups; n is an integer from 0 to 1;

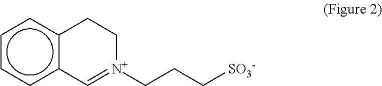

3-(3,4-dihydroisoquinolinium)propane sulphonate;
and mixtures thereof.

More preferably, the aryliminium zwitterions have the structure:

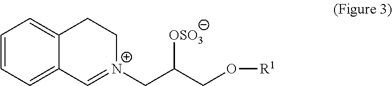

wherein: in FIG. 3, R¹ is a branched alkyl group containing from 9 to 24 carbons or linear alkyl group containing from 11 to 24 carbons, preferably, each R¹ is a branched alkyl group containing from 9 to 18 carbons or linear alkyl group containing from 11 to 18 carbons, more preferably each R¹ is selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Suitable aryliminium zwitterions include those listed in Table 1a, Table 1b, and mixtures thereof. Preferred aryliminium zwitterions are those listed in Table 1b, and mixtures thereof. Most preferred, are the inner salts of 3-(3,4-dihydroisoquinolinium) propane sulphonate, sulphuric acid mono-[2-(3,4-dihydro-isoquinolin-2-yl)-1-(2-butyl-octyloxymethyl)-ethyl]ester, and mixtures thereof.

Suitable aryliminium cations and polycations having the structure:

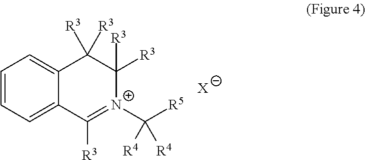

wherein: in FIG. 4, R³ is independently selected from the group consisting of: H and methyl groups. Preferably, R³ is H. R⁴ and R⁵ are independently selected from the group consisting of: H, a branched alkyl group containing from 3 to 12 carbons, and a linear alkyl group containing from 1 to 12 carbons. Preferably, R⁴ and R⁵ are H or methyl, more preferably, R⁴ and R⁵ are H. X⁻ is a charge-balancing counter-ion; preferably a bleach-compatible counter-ion. Suitable aryliminium cations include those listed in Table 2, and mixtures thereof. Most preferred, are N-methyl-3,4-dihydroisoquinolinium tetrafluoroborate, N-methyl-3,4-dihydroisoquinolinium p-toluene sulphonate, and mixtures thereof.

The wash liquor may comprise an adjunct ingredient wherein the adjunct ingredient is selected from soap, brightener, carboxymethylcellulose, enzymes, soil release polymer, surfactant or a mixture thereof.

The wash liquor may be formed by the addition of a powder detergent, a liquid detergent, a water-soluble unit dose article, or a mixture thereof to water. Those skilled in the art will be aware of how to make a wash liquor.

The wash liquor may also comprise the addition of other common laundry cleaning or care compositions, such as stain remover pre-treaters, fabric softeners, scent boosters (such as Lenor or Downy Unstoppables product) or a mixture thereof.

### Acyl Hydrazone Bleach Catalyst

The wash liquor comprises between 0.5 ppm and 5 ppm, preferably between 1 ppm and 4 ppm acyl hydrazone bleach catalyst.

Preferably, the acyl hydrazone bleach catalyst has the formula I;

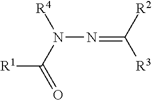

wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof.

More preferably, the acyl hydrazone bleach catalyst is 4-(2-(2-((2-hydroxyphenylmethyl)methylene)-hydrazinyl)-2-oxoethyl)-4-methylchloride having the formula II;

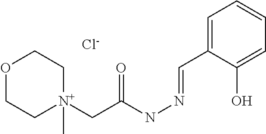 [SMILES: C[N+]1(CC(=O)N/N=C/c2ccccc2O)CCOCC1 ; [Cl-]]

Acyl hydrazone bleach catalysts boost the bleaching action of peroxidic bleaching agents, without unduly damaging the substrate to be cleaned, for example the fabric. The peroxidic bleaching agents are preferably H₂O₂ or substances that release H₂O₂ in water, including in particular alkali metal perborates, alkali metal percarbonates and urea perhydrates; however, they may be also possibly employed combined with peroxycarboxylic acids, such as diperoxydecanedicarboxylic acid or phthalimido peroxycaproic acid, with other acids or acidic salts, such as alkali metal persulfates or alkali metal peroxydisulfates or Caroates, or with diacyl peroxides or tetraacyl diperoxides.

Acyl hydrazones may be processed into the detergent in the form of a granulate. The granulate may be a two-layer coated granulate comprising;
a) a core pellet comprising 5 to 40% by weight based on the weight of the total granule of an acyl hydrazone of formula (I) and 1-10% by weight based on the weight of the total granule of water and/or water soluble binder which is selected from the group consisting of polyvinylalcohols, polyvinylpyrrolidones, polyacrylates, cellulose derivatives, carbohydrates, polyethyleneglycols and mixtures thereof;
b) 0.1% to 25% by weight based on the weight of the total granule of a subcoating comprising a polymer mixture of hydoxypropylmethylcellulose (HPMC) and methylcellulose (MC) in a ratio by weight of from 2:1 to 8:1;
c) 1 to 25% by weight based on the weight of the total granule of a topcoating comprising a fatty acid selected from nonadecanoic acid, stearic acid, palmitic acid, myristic acid and mixtures thereof; and
d) other components
   the sum of components (a) to (d) adding to 100%.

Preferably, the acyl hydrazone bleach catalyst is comprised within a granule, wherein preferably the granule comprises between 5% and 40% by weight of the granule of the acyl hydrazone bleach catalyst.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for washing fabrics comprising the steps;
a. contacting fabrics to be washed and a wash liquor in the drum of an automatic washing machine;
b. washing the fabrics in the wash liquor in an automatic washing machine process, wherein the automatic washing machine process comprises at least a main wash step;
wherein the wash liquor comprises;
i. between about 0.5 ppm and about 5 ppm acyl hydrazone bleach catalyst;
ii. between about 10 ppm and about 2500 ppm non-soap surfactant;
iii. between about 50 ppm and about 2500 ppm of a hydrogen peroxide source, and
wherein the wash liquor has a pH between about 6 and about 9.

2. The process according to claim 1, wherein the wash liquor has a pH between about 7 and about 8.5.

3. The process according to claim 1 wherein the wash liquor comprises
a. a bleach activator,
b. a second bleach catalyst wherein the second bleach catalyst is different than the acyl hydrazone bleach catalyst;
c. or a mixture thereof.

4. The process according to claim 3 wherein the bleach activator is selected from tetra-acetyl-ethylene-diamine, nonanoyl oxybenzene sulphonate or a mixture thereof.

5. The process according to claim 3 wherein the second bleach catalyst is selected from a complex of a transition metal, an aryliminium organic bleach catalysts or a mixture thereof.

6. The process according to claim 1 wherein the main wash takes between about 5 minutes and about 50 minutes.

7. The process according to claim 1 wherein the main wash step comprises the addition of between about 10 L and about 60 L, of water to the drum of the automatic washing machine.

8. The process according to claim 1 wherein the temperature of the water in the main wash step is between about 10° C. and about 45° C.

9. The process according to claim 8 wherein the temperature of the water in the main wash is between about 15° C. and about 35° C.

10. The process according to claim 1, wherein the automatic washing process comprises at least one rinse step.

11. The process according to claim 1 wherein the automatic washing machine process comprises a final rinse step.

12. The process according to claim 11 wherein the drum of the automatic washing machine rotates at a speed of between 500 rpm and 1700 rpm during the final rinse step.

13. The process according to claim 1 wherein the non-soap surfactant is selected from anionic surfactants, non-ionic surfactants, cationic surfactants or a mixture thereof.

14. The process according to claim 1 wherein the acyl hydrazone bleach catalyst has the formula I; 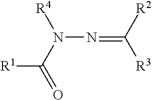
wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof, preferably wherein the acyl hydrazone bleach catalyst is 4-(2-(2-((2-hydroxyphenylmethyl)methylene)-hydrazinyl)-2-oxoethyl)-4-methylchloride having the formula II;

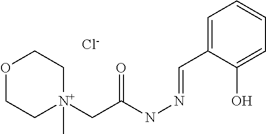 [SMILES: C[N+]1(CC(=O)N/N=C/c2ccccc2O)CCOCC1 ; [Cl-]]

15. The process according to claim 1 wherein the wash liquor comprises between about 1 ppm and about 4 ppm acyl hydrazone bleach catalyst.

16. The process according to claim 1 wherein the wash liquor comprises between about 15 ppm and about 1000 ppm, of non-soap surfactant.

17. The process according to claim 16 wherein the wash liquor comprises between about 250 ppm and about 2000 ppm, of the hydrogen peroxide source.

18. The process according to claim 17 wherein the wash liquor comprises between about 500 ppm and about 1500 ppm of the hydrogen peroxide source.

19. The process according to claim 1 wherein the hydrogen peroxide source is selected from alkali metal perborates, alkali metal percarbonates, urea perhydrates, peroxycarboxylic acids, alkali metal persulfates, alkali metal peroxydisulfates, Caroates, diacyl peroxides, tetraacyl diperoxides or a mixture thereof.

20. The process according to claim 1 wherein the wash liquor comprises an adjunct ingredient wherein the adjunct ingredient is selected from soap, brightener, carboxymethylcellulose, enzymes, soil release polymer, surfactant or a mixture thereof.
